(19) United States
(12) Patent Application Publication
(10) Pub. No.: US 2002/0095607 A1
(43) Pub. Date: Jul. 18, 2002

(54) Security protection for computers and computer-networks

(76) Inventor: Catherine Lin-Hendel, Los Gatos, CA (US)

Correspondence Address: Jean-Marc Zimmerman, 226 St. Paul Street, Westfield, NJ, 07090, US

(21) Appl. No.: 10/052,645

(22) Filed: Jan. 19, 2002

Related U.S. Application Data
(60) Provisional application No. 60/262,966, filed on Jan. 18, 2001.

(51) Int. Cl. G06F 12/14

(52) U.S. Cl. 713/201

(57) ABSTRACT

A virus and intrusion protection apparatus for use with a personal computer or the like, and a computer network that adds a dedicated network board for exclusive communications with an external network, the World-Wide-Web and email. The dedicated network board includes the necessary duplicated computing components to isolate the Main Core of the computer or network server from external communications with the World-Wide-Web such as a central processing unit, memory, communications ports, needed modems, etc. During external communications, a switch connecting the dedicated network board to the Main Core of the computer or network server is opened. Booby trap ghost address book and ghost directories are added in the access board to trap new viruses that is not detected by the existing inspection programs.

### CROSS REFERENCE TO RELATED APPLICATIONS

This application claims priority from the U.S. Provisional Patent Application Serial No. 60/262,966 filed on Jan. 20, 2001.

### FIELD OF THE INVENTION

This invention relates to virus and intrusion protection devices for computers and computer-networks, and more particularly to a computer or a network server having a virus and intrusion protection apparatus that includes a separate, dedicated board with its own CPU, memory, and communications ports (hereinafter referred to as the “Network Board”) exclusively for accessing and communicating with external networks, including but not limited to the World-Wide-Web and receiving and sending emails. Also included is a switch that physically severs the connection between this dedicated network board and the rest of the computer or computer-network, when this dedicated network board is connecting to, or is connected to an external network.

### BACKGROUND OF THE INVENTION

Protection against destruction from computer viruses is conventionally done with virus protection software, which compiles “footprints” of known viruses, and detects incoming files for such footprints. Files containing similar suspicious footprints are rejected, deleted, or isolated. However, such virus protection software cannot protect against new viruses with “footprints” yet unknown to the installed protection software. Furthermore, this conventional approach does not protect the security, confidentiality and integrity of computers and computer-networks from other intrusions, and computer worms and viruses that may embed themselves in web pages. Neither does the conventional approach protect against spying software mistakenly or purposefully installed on computers or computer networks to snoop, and steal information, such as by automatically sending the stolen information directly from the compromised computers or computing network through the World-Wide-Web.

In a networked environment, many individual computers of a company, for example, are connected with each other through LAN (Local Area Network) servers and other networked servers (such as print servers, file servers, etc.), and share additional devices and software through the network. Web- and Email- servers serve the network. Conventional “firewall” and “virus detection” software are employed in the Web- and Email- servers to perform network access identification, verification, permission, and denial. However, channels must exist at all times to allow incoming and outgoing emails, data transfers, and access to the World-Wide-Web from inside the network. These “always on” channels are serious security risks. The virus detection software for the network has the same risks as discussed previously in the case of individual computers.

### SUMMARY OF THE INVENTION

The present invention contemplates a virus and intrusion protection apparatus for use with computers and/or computer-networks that adds to a computer or a network-server a dedicated Network Board exclusively for external communications with external networks, such as the World-Wide-Web. A switching mechanism is also included in the apparatus to disconnect the dedicated Network Board from the rest of the Main Core of the computer (or network server)—such as, without limitation, its CPU, storage devices, software and communications buses.

In operation, the switching mechanism is normally open (physically or virtually), and the Main Core of the computer is disconnected from the dedicated Network Board and the external network, such as, without limitation, the World-Wide-Web. A request is made to connect the Main Core of the computer (or server) to the dedicated Network Board. In such case, the connection between the Network Board and the external network is automatically severed, before the connection is made between the Network Board and the Main Core of the computer (or network server). When the dedicated Network Board is connecting to, or is connected to an external network or the World-Wide-Web, the connection between the dedicated Network Board and the Main Core of the computer (or network server) is automatically severed.

### BRIEF DESCRIPTION OF THE DRAWINGS

FIG. 1 illustrates a computer with the virus and intrusion protection apparatus in accordance with the present invention.

FIG. 2 illustrates a computer network with the virus and intrusion protection apparatus in accordance with the present invention.

### DETAILED DESCRIPTION OF THE INVENTION

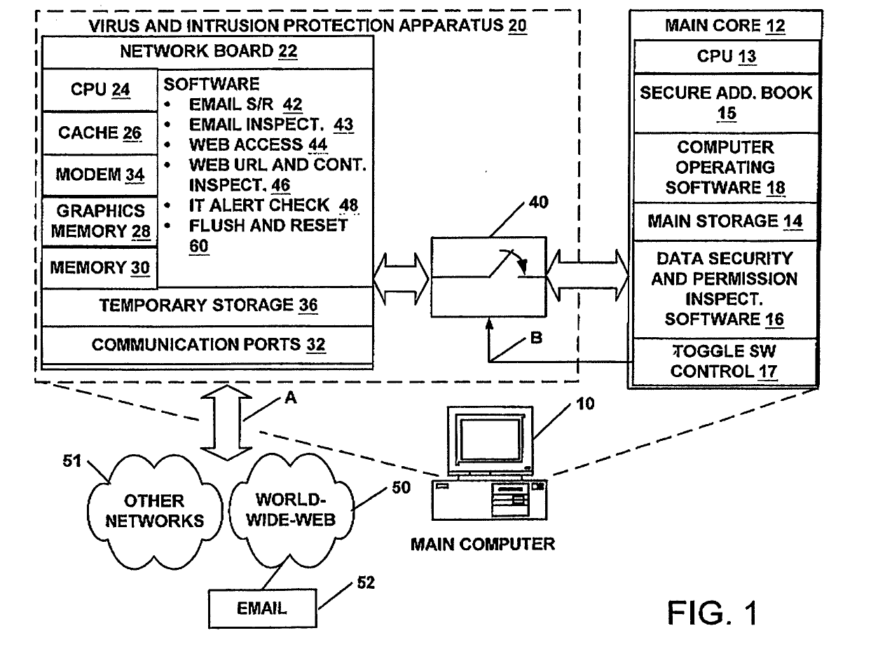

Referring now to the FIG. 1, the present invention includes a main computer 10, such as a personal computer, laptop or the like, with the added virus and intrusion protection apparatus 20. The virus and intrusion protection apparatus 20 is an added dedicated board 22 having its own CPU 24, cache 26, graphics or RAM memory 28, other memory 30, temporary storage media 36 and communications ports 32 exclusively for external communications, such as accessing and communicating with the World-Wide-Web 50, other external networks 51, and sending and receiving email 52. The virus and intrusion protection apparatus 20 further includes a switching mechanism 40. The added, dedicated board 22 will hereinafter sometimes be referred to as the “Network Board 22.” It should be noted that while the virus and intrusion protection apparatus 20 is illustrated as separate from the housing of the conventional main computer 10, the virus and intrusion protection apparatus 20 may be installed in the housing of the main computer 10 or may be separate from the housing of the main computer 10.

Network Board 22 includes software for operating the CPU 24, storing information, and performing external communications, such as accessing the World-Wide-Web 50 via web access software 44, other external networks 51, and receiving and sending email 52 via email send and receive (SR) software 42. For example, the software residing on the Network Board 22 includes email and data inspection software 43 that routinely exams the security level and appropriateness of the outgoing data, before the data is sent to the external world (World-Wide-Web 50, other external networks 51, and sending and receiving email 52). The email and data inspection software 43 also exams the incoming email and other data from the external world. The software further includes IT (information technology) Department alert check software 48 that automatically performs a check for new viruses and problems in an IT Department Bulletin posting (which could alternately be a service provided by an Internet Service Provider) identifying such new viruses and problems, before the Network Board 22 allows the connection to be executed to the rest of the computer 10, the Main Core 12, and incoming data stored in the temporary storage media 36 transferred to the Main Core 12 of the computer 10.

It should be noted that the inspection software 43 and 46 detect for viruses and problems that are known at the time of installation. While these inspection software 43 and 46 are updated from time to time, alert check software 48 provides for added detection of new viruses and problems that are not yet included in the inspection software 43 and 46. As with external communications, the Network Board 22 may further include firewall software and the like.

Note that the email SR software 42 contains encryption, send/receive, and tamper detection functions, and does not contain the email address book 15. The email address book 15 resides securely within the Main Core 12 of the computer 10 and is otherwise secure. Instead, a “booby trap” address book with ghost addresses is implemented in the email SR software 42. Therefore, if and when an undetected virus attempts to commandeer the “address book” to send itself to all addresses listed (the most common way viruses are spread), detection and alert is made and issued by this “booby trap” address book.

Since the Main Core 12, with its main components, software, and storage media 14 of the computer 10 is never exposed to the World-Wide-Web 50 and/or other external networks 51 while communication sessions therewith commence, no hacker, worm or virus can invade, infect or affect the Main Core 12 of the computer 10. The temporary storage media 36 of the Network Board 22 can easily be flushed and restored by flush and restore software 60.

The Network Board 22 further includes modem 34, which is connected to the Network Board 22 but not necessarily reside thereon. Accordingly, the Network Board 22 contains computing components for external communications with the external world (World-Wide-Web 50, other external networks 51, and sending and receiving email 52), so that the Main Core 12 and the rest of the computer 10 can be isolated during such external communications. In case that the present invention is implemented as an add-on to a conventional computer which has an existing modem on the Main Core 12, the modem can be disconnected from the Main Core 12, and connected to the Network Board 22.

The communications functions to the external world of the Network Board 22 have been separated from the Main Core 12 and the rest of the computer 10, to protect the Main Core 12 from human hackers, intrusions or spy software, and viruses and worms including those that may embed themselves in web pages. Furthermore, the virus and intrusion protection apparatus 20 includes a separate temporary storage media 36 that is dedicated to temporary storage of information/data received from the external world and for data to be sent to the external world.

Referring now to the switching mechanism 40, switching mechanism 40 provides the connectivity between the Network Board 22 and the Main Core 12 of the computer 10, its CPU 13, its programs or operating software 18, its storage, and its data.

As shown, normally, the switching mechanism 40 is open. When the switching mechanism 40 is open, the World-Wide-Web 50, other external networks 51, and email 52 are only connected to the Network Board 22 via a network communications port A. Therefore, the Network Board 22 is otherwise disconnected from the Main Core 12 of the computer 10. When the computer user needs data from the Main Core 12 of the computer 10 to be sent to receiver(s) at/through an external network, such as the World-Wide-Web 50, the Network Board 22, at first, severs the network connection on communications port A. Thereafter, the switching mechanism 40 to the Main Core 12 of the computer 10 closed. Then, the needed files from the Main Core 12 are checked for security, classification, confidentiality, permission-to-be-sent, destination-permission, etc., as well as, the appropriateness of the content via the data security and permission inspection software 16. After send-permission is granted, the needed files from the Main Core 12 are accessed and deposited to the temporary storage media 36 of the virus and intrusion protection apparatus 20.

When the computer 10 is commanded to connect to the World-Wide-Web 50, other external networks 51, or to send and receive email 52, the switching mechanism 40 that connects the Network Board 22 to the Main Core 12 of the computer 10 is automatically thrown open via control line B via a request generated by switch control software 17 of the Main Core 12. Thus, the Main Core 12 of the main computer 10 is protected from the connection to the outside world on the communications port A to the Network Board 22. The switch control software 17 can be duplicated or alternately installed on the Network Board 22. It is desirable to install the portion that disconnects switching mechanism 40, and connects communications port A to the external network, on the Network Board 22. The connect command to switching mechanism 40 is best issued via the Main Core 12.

When a command is issued to the Network Board 22 to connect to the outside world, and a data-sending request is made, switching mechanism 40 is thrown open, the data to be sent is again inspected for security level, permissions to be sent to outside world, and the appropriateness of the content, before the connection and sending can commence.

Emails and Data from the outside world are inspected and cleaned via email and data inspection software 43 and/or web URL and content inspection software 46 when appropriate. After the data from the outside world via communications port A is inspected and cleaned, such inspected and cleaned data is stored in temporary storage media 36. When the inspected and clean data residing in the temporary storage media 36 of the Network Board 22 is desired for permanent storage in main storage media 14 of the Main Core 12, the “alert check” software 48 can serve as an additional safeguard. In this case, the IT department (or an ISP) would create an “alert bulletin board” posting any new viruses and/or other problems that may not yet be protected by the existing security check software. The bulletin would post information of new viruses or problems, list key words, footprints contained in such new viruses or problems, and the URLs of web pages that contains new problems. The “alert check” would automatically access the “alert bulletin board” and check the demanded data against the list on the “alert bulletin board.” Abstract news and pass/fail information would be posted on the computer screen for user review. Passed data would be automatically transferred to the main core storage 14. Failed data would be isolated, scrubbed, or deleted, and a warning issued for user review. When the data is thus also cleared, thereafter network communications port A is severed, and the switching mechanism 40 is closed. Files from the temporary storage media 36 can then be safely moved to the core's storage media 14 of the main computer 10.

If data coming into the Network Board 22 is infected with a known virus or problem, such virus/problem would be caught by the inspection software 43 and/or 46, and isolated or deleted from within the Network Board 22, and prevented from creating damages. A new virus that is unknown to the inspection software 43 and/or 46, if accessed and opened in Network Board 22, would only make very limited damage to Network Board 22, such damage is easily caught and repaired.

If a request to transfer incoming data that is “tested clean” to the main computer 10, but might contain new viruses or problems already caught by IT of (ISP) awareness while not yet covered in inspection software 43 and 46, the optional alert check software 48 can check any files/data that has the potential of containing a new virus or worm—(such as containing an executable file, or a file that can contain an embedded executable command) against the IT department “alert bulletin board” as described in the previous paragraph.

As an additional safety guard, switching mechanism 40 can be designed to be physically and manually accessed and disconnected or connected from outside of the computer 10. When the switching mechanism 40 is “physically” and manually thrown open from the outside physical access, the switch control software 17, whether residing on the Network Board 22, or the Main Core 12, cannot close the switching mechanism 40. In this case, the switch control software 17 can only connect and disconnect the switching mechanism 40 through control line B, when the “physical switch” outside of the computer 10 is physically and manually “closed.”

Whenever an external-network connection command is issued or when a connection to an external network via communication port A is detected, the switch control software 17 issues a command on control line B to open switching mechanism 40. The switching mechanism 40, when closed, forms a connection between the Network Board 22 and the Main Core 12 of the computer 10.

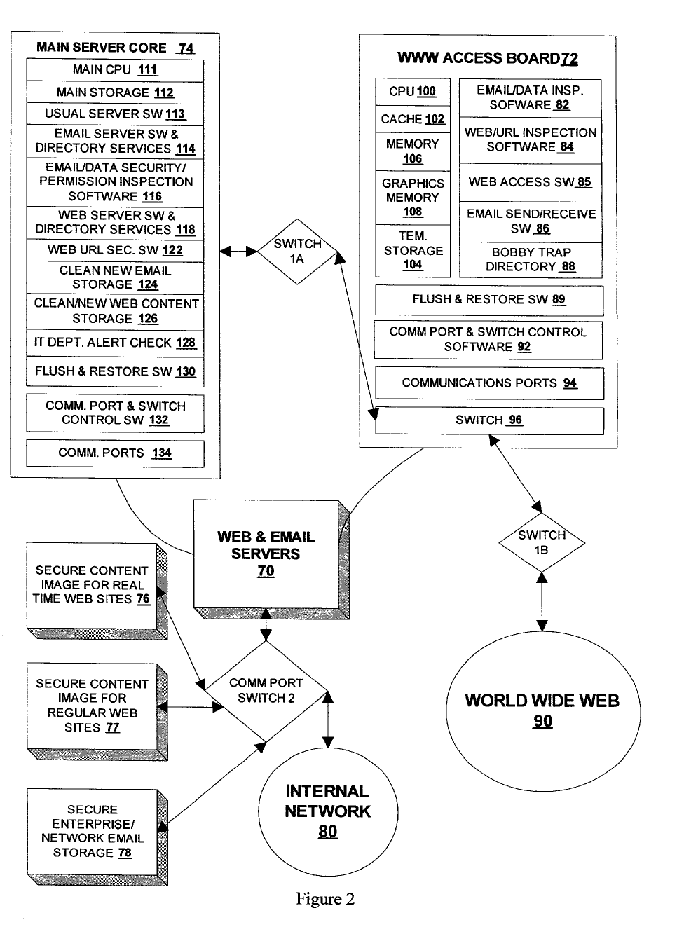

Referring now to FIG. 2, the present invention applies in computer networks. A dedicated WWW access board 72 is added to a conventional web and email server 70 wherein the web and email server 70 includes a Main Server's Core 74. The Main Server's Core 74 includes a main CPU 111, main storage 112, conventional server software 113, email server software and directory services 114, email/data security and permission inspection software 116, web server software & directory services 118, web URL and security inspection software 122, clean new email storage 124, clean new web content storage 126, IT department alert check software 128, flush and restore software 130, communications port and switch control software 132, and communications ports 134. Elements 116, 122, 124, 126, 128, 130, and 132 are elements of this invention, and can alternately be installed on WWW access board 72.

The dedicated WWW access board 72 contains its own CPU 100, cache 102, temporary storage device 104, memory 106, graphics memory 108, email and data inspection software 82, web/URL inspection software 84, web access software 85, and email send/receive software 86. The dedicated WWW access board 72 further includes its own communications ports 94 and switching mechanism 96 that either connects the WWW access board 72 to the main server's core 74, via switch 1A, or to the World-Wide-Web 90 via communications ports 94, and switch control software 92. The switch control software 92 can be duplicated or alternately installed or duplicated on the Main Server's Core 74. It is desirable to install only the capability to connect (close) switching mechanism 96 to the external network on the WWW access board 72 via switch 1B, and not the capability to connect to the Main Server's Core 74 via switch 1A. The connection command for connecting the WWW access board 72 to the Main Server's Core 74 is preferably issued by the Main Server's Core 74. The WWW access board 72 can be within or outside of the housing of the Web and Email Server 70.

Conventionally, the computing, printing, storage, and other devices in a Local Area Network (LAN) are connected through a LAN server. The Local Area Network is hereinafter referred to as the Internal Network 80. The Internal Network 80 is connected to the World-Wide-Web 90 through a combination of Web- and Email- Servers 70 that are constantly connected to the World-Wide-Web 90. Web- and Email- Servers 70 serve all individual computers on the Internal Network 80 in their connections to the outside world. LAN servers serve the individual computers in the network in connecting to each other and other devices in the Internal Network 80. Conventional “firewall” and virus detection software usually included in the conventional server software 113 are installed in the Web- and Email- Servers 70. Firewall software performs network access identification, verification, permission, and denial. However, channels through the firewall are open at all times to allow incoming and outgoing emails and data, as well as WWW access. These “always on” open channels can be probed from the outside, and constitute serious security issues. Alternately the firewall software can be installed on the separate and dedicated WWW access board 72.

The separate and dedicated WWW access board 72 of this invention contains a switch mechanism 96, which includes switch 1A and switch 1B. Switch 1A disconnects the external communications ports 94 of WWW access board 72 from the rest of the Internal Network 80, when the WWW access board 72 is connected to an external network such as the WWW 90 through switch 1B. Switch mechanism 96 can be controlled by both communications port and switch control software 92 and 132. Switch 1B is controlled primarily by communications port and switch control software 92, and Switch 1A is controlled primarily by communications port and switch control software 132.

The directory and addresses of the devices and users in and of the Internal Network 80 resides within the Main Server's Core 74, along with the email server software and directory services 114. On the WWW Access Board 72, the email S/R software 86 contains a moderate set of needed functions, such as encryption/decryption, sends and receives, and a new booby-trap directory 88 that contains no real addresses and identification of devices in the internal network 80, but contains trap functions and ghost/alert addresses to trap those viruses that are programmed to usurp and commandeer a directory/address book to propagate itself. This booby-trap directory 88 also alerts system administrators of virus invasions, even when the invading viruses are not detected and rejected or isolated by the email and data inspection software 82.

Web URL security software 122 inspects the internal requests for URL accesses against a list of unsafe/problem or blocked URLs. The web/URL inspection software 84 inspects the pages of permitted requests which passed Web URL security software 122, for page contents health, which might at the mean time have embed bugs worms and viruses by hackers, or might otherwise be defaced or contaminated by “information terrorists”. One also might want to have the preliminary, quicker inspections residing on the WWW access board 72, and have the more exhaustive inspections done on the more powerful main core. Email and data security software 116 primarily exams the data classification, confidentiality, and sent and destination permission.

The Internal Network 80 directly accesses the internal clean and secure Web Content Images from large banks of internal storage devices 76 and 77 that store clean and secure web images downloaded from and updated by the secure web content storage 126 residing on the main server board 74. The internal network 80 also directly accesses a clean and secure email repository contained in a large internal bank of storage devices 78, downloaded from and updated by the secure clean email storage 124 residing on the main server board 74. The secure content image for real time web sites in storage device 76, is a clean and secure image of dynamic real-time information websites with frequently changing information, such as stock quotes. The images in the storage device 76 receive frequent updates. It can also check for the status of last change of a particular information at the instance of access request for that particular information. The Secure Web Content Image storage device 77 includes a clean and scrubbed image of websites that do not change content as dynamically as those imaged in the Real Time Secure Web Content Image do, and can be updated at less frequent intervals. In fact, the internal secure web image storage devices 76 and 77 can contain only those websites/information that corporate (or organizational) policies permit or encourage employees/members to access. This provides the benefits of not having employees/members misusing work time and organizational resources for private needs, such as visiting pornography or entertainment sites.

In operation, the newly arrived and the update information from the WWW 90 is first scrubbed by WWW Access Board 72, then inspected and scrubbed again by the Main Server's Core 74 before being downloaded to the internal storage devices 76 and 77, and the internal secure email repository 78.

When needed, switching mechanism 2 can be opened to totally sever exposure of the Internal Network 80 to the Main Server's Core 74 and its storage 124 and 126, while still connected to the storage devices 76, 77, and secure email storage 78. These secure images and storages are never directly exposed to the external network, such as the WWW 90, and remains secure for internal access at all times.

The Main Server's Core 74 includes Web Server software and directory services 118 that are well known and commonly used in industry. Conventional email repositories in conventional computers and computer networks are exposed to outside tampering when the computers or the computer networks are connected to the WWW 90. Additionally, these conventional email storages are at risk for programmed attacks that invaded/compromised the computers or computer networks even when not connected to the network.

In the present invention, emails once in the clean secure internal storage device 78 are scrubbed, clean, safe, with no programmed sleeper timed-bombs or sneak stealing, and not reachable by outside tempering.

Regarding internal storage devices 76 and 77 for website images, the website images are cleaned and scrubbed copies of all website images permitted to be accessed by users in the Internal Network 80—say, the Applied Materials Network, or the Lucent Network. To install, these images, one may start with downloading a basic set of “blessed/permitted websites” which are the standard websites such as without limitation, Yahoo, Amazon, . . . plus industry information sites, USPTO site, and other government sites, fortune 2000 corporate sites, competitor sites, etc.; and installing a list of “exclusions,” such as the known porn sites. Henceforth, when an URL access request comes from the Internal Network 80 that is not contained in internal storage devices 76 or 77, it is compared to the “exclusion list,” and when not in the “exclusion list,” WWW access board 72 connects to the WWW 90 and goes to get a copy of that URL, and if appropriate, exam and copy all of the URLs on that website, and transfer the scrubbed clean content to internal storage devices 76 or 77 as appropriate.

The Main Server's Core 74 includes IT alert check software 128 similar to the IT alert check software described in FIG. 1 and Communications Ports 134 are buses that connects to various data/communications lines or buses.

The operation of switch 2 will now be described. When and if the Main Server's Core 74 is compromised, which should be rare, switch 2 is opened from the Web and Email Servers 70 so that Internal Network 80 and internal storage devices 76, 77, and 78 are not compromised. Internal storage devices 76, 77 and 78 are normally connected to the Internal Network 80. When there is external communications needs/requests made from inside the Internal Network 80, Internal Network 80 would be connected to the Main Server's Core 74, —which could be nearly “all” the time during work hours, and not so much in the evenings in a corporate environment.

Numerous modifications to and alternative embodiments of the present invention will be apparent to those skilled in the art in view of the foregoing description. Accordingly, this description is to be construed as illustrative only and is for the purpose of teaching those skilled in the art the best mode of carrying out the invention. Details of the structure may be varied substantially without departing from the spirit of the invention and the exclusive use of all modifications which come within the scope of the appended claims is reserved.

What is claimed is:

1. Virus and intrusion protection apparatus for use with a computer comprising:
a dedicated network board exclusively for external communications with the World-Wide-Web, email and other external networks; and
a switch connecting the dedicated network board and a main core of the computer wherein when the switch is open, the main core of the computer is disconnected from the dedicated network board and the World-Wide-Web, email and other external networks.

2. The apparatus according to claim 1, wherein the dedicated network board includes:
a central processing unit (CPU);
cache;
memory; and
communications ports and software for communicating with the World-Wide-Web, email and other external networks.

3. The apparatus according to claim 2, wherein the dedicated network board further includes a modem.

4. The apparatus according to claim 1, further comprising a modem coupled to the dedicated network board.

5. The apparatus according to claim 1, wherein the dedicated network board further comprises:
temporary storage media for storing information from the World-Wide-Web;
email software for sending and receiving email;
web access programs for communicating with the World-Wide-Web; and
inspection software for emails and world-wide-web communications.

6. The apparatus according to claim 5, wherein the email software comprises a booby tray address book and the main core comprises an email address book of email recipients.

7. The apparatus according to claim 5, wherein the dedicated network board further comprises:
flush and reset software for flushing and resetting the temporary storage media upon detection of a virus.

8. The apparatus according to claim 1, wherein when transferring data from the dedicated network board to the main core, a connection to the World-Wide-Web, the email or the other external network is severed, the computer commands the switch to close and thereafter data is transferred from the temporary storage media to storage media of the main core.

9. A method for protecting a computer from a virus, hacker or worm comprising the steps of:
providing a dedicated network access board exclusively for communications with World-Wide-Web, email and other external networks;
connecting a main core of the computer to the dedicated network access board via a switch; and
opening the switch to connect the World-Wide-Web, the email or the other external networks to the network board via a network connection and disconnecting the World-Wide-Web, the email and the other external networks from the main core of the computer to protect the computer from the virus, the worms, or the hackers.

10. The method according to claim 9, wherein the method further includes the steps of:
when data is desired from the main core of the computer:
severing the network connection to the World-Wide-Web, the email or the other external network;
closing the switch to establish a connection between the dedicated network board and the main core of the computer; and
transferring files from the dedicated network board to a storage media of the main core.

11. The method according to claim 9, further comprising the steps of:
commanding the computer to connect to the World-Wide-Web, the email or the other external network; and
in response to the commanding step, automatically opening the switch to disconnect the main core from the World-Wide-Web, the email or the other external network.

12. The method according to claim 9, further comprising the steps of:
when transferring clean data obtained from the World-Wide-Web, the email or the other external network to the main core:
severing the network connection;
closing the switch; and
transfer files from the temporary storage media to the core's storage media.

13. Virus and intrusion protection apparatus for use with a computing unit comprising:
means dedicated to exclusive external communications with World-Wide-Web; and
means for switching the dedicated external communications means and a main core of the computing wherein when the switching means is open, the main core of the computing unit is disconnected from the dedicated external communications means and the World-Wide-Web while communications commence with the World-Wide-Web.

14. The apparatus according to claim 13, wherein the computing unit is a computer.

15. The apparatus according to claim 14, wherein the dedicated external communications means includes:
a central processing unit (CPU);
cache;
memory; and
communications ports and software for communicating with the World-Wide-Web.

16. The apparatus according to claim 15, wherein the dedicated external communications means further comprises:
temporary storage media for storing information from the World-Wide-Web;
email software for sending and receiving email;
web access programs for communicating with the World-Wide-Web; and
inspection software for emails and world-wide-web communications.

17. The apparatus according to claim 16, wherein the email software comprises a booby tray address book and the main core comprises an email address book of email recipients.

18. The apparatus according to claim 17, wherein the dedicated external communications means further comprises:
flush and reset software for flushing and resetting the temporary storage media upon detection of a virus.

19. The apparatus according to claim 18, wherein when transferring data from the dedicated external communications means to the main core, a connection to the World-Wide-Web is severed, the computer commands the switching means to close and thereafter data is transferred from the temporary storage media to storage media of the main core.

20. The apparatus according to claim 13, wherein:
the computing unit is a network server; and
the dedicated external communications means includes:
a central processing unit (CPU);
cache;
memory; and
communications ports and software for communicating with the World-Wide-Web.
